(19) United States
(12) Patent Application Publication
(10) Pub. No.: US 2017/0233662 A1
(43) Pub. Date: Aug. 17, 2017

(54) SATURATOR AND METHOD FOR REUSING WATER FROM A FISCHER-TROPSCH REACTOR

(71) Applicants: SHELL INTERATIONALE RESEARCH MAATSCHAPPIJ B.V., The Hague (NL); SHELL OIL COMPANY, Houston, TX (US)

(72) Inventors: Gerald SPRACHMANN, Amsterdam (NL); Johan Peter DEN BREEJEN, Amsterdam (NL); Ruben SMIT, Amsterdam (NL); Matthias BEHN, Amsterdam (NL)

(21) Appl. No.: 15/515,163

(22) PCT Filed: Sep. 29, 2015
(86) PCT No.: PCT/EP2015/072331

§ 371 Date: Mar. 29, 2017

(30) Foreign Application Priority Data
Sep. 30, 2014 (EP) 14187108.7

(51) Int. Cl. C10G 3/00; C02F 1/70; C02F 1/68; B01J 8/02; C10G 2/00

(52) U.S. Cl. CPC C10G 3/50; B01J 8/0278; B01J 8/0242; C10G 3/47; C10G 3/48; C10G 2/30; C02F 1/68; C02F 1/70; B01J 2208/00893; C10G 2300/1003; C10G 2300/1022; C10G 2300/202; C02F 2101/34

(57) ABSTRACT

The present invention relates to a saturator. The present invention further relates to a method for reusing a waste water stream from a Fischer-Tropsch reactor. The invention further relates to system for recycling waste water from a Fischer-Tropsch reactor preferably within a gas-to-liquids (GTL) plant.

### FIELD OF THE INVENTION

The present invention relates to a gas saturator. The present invention further relates to a method for reusing water from a Fischer-Tropsch reaction within for example a gas-to-liquids (GTL) plant.

### BACKGROUND TO THE INVENTION

The Fischer-Tropsch process can be used for the conversion of synthesis gas into liquid and/or solid hydrocarbons. The synthesis gas may be obtained from hydrocarbonaceous feedstock in a process wherein the feedstock, e.g. natural gas, associated gas and/or coal-bed methane, heavy and/or residual oil fractions, coal, biomass, is converted in a first step into a mixture of hydrogen and carbon monoxide. This mixture is often referred to as synthesis gas or syngas. Synthesis gas is produced in the syngas manufacturing unit of a GTL plant. Formation of syngas from methane occurs according to the following reaction:

CH₄+H₂O [symbol] CO+3H₂

Since water in needed for this reaction to occur typically water is added to the feed gas via direct stream injection or alternatively via saturating the feed gas with water in a saturator up stream of the syngas producing unit.

The synthesis gas preferably comes from steam reforming and/or from the partial oxidation of natural gas, typically methane, and/or other heavier hydrocarbons, possibly present in natural gas (e.g., ethane, propane, butane). In a steam reforming process, natural gas is generally mixed with steam in a saturator and is passed through a catalytic bed comprising a catalyst in a synthesis manufacturing unit. Synthesis gas can also be derived from other production processes such as, for example, auto-thermal reforming or the process known as C.P.O. (Catalytic Partial Oxidation). In the latter process streams of high-purity oxygen or enriched air together with desulfurized natural gas and a catalyst are used, or from the gasification of coal or other carbonaceous products, with steam at a high temperature.

The obtained synthesis gas is fed into a reactor where it is converted in one or more steps over a suitable catalyst at elevated temperature and pressure into paraffinic compounds and water by Fischer-Tropsch process. The obtained paraffinic compounds range from methane to high molecular weight modules. The obtained high molecular weight modules can comprise up to 200 carbon atoms, or, under particular circumstances, even more carbon atoms. Numerous types of reactor systems have been developed for carrying out the Fischer-Tropsch reaction. For example, Fischer-Tropsch reactor systems include fixed bed reactors, especially multi-tubular fixed bed reactors, fluidized bed reactors, such as entrained fluidized bed reactors and fixed fluidized bed reactors, and slurry bed reactors such as three-phase slurry bubble columns and ebulated bed reactors.

In a Fischer-Tropsch (FT) process carbon monoxide and hydrogen (ingredients of syngas) are converted into hydrocarbons and water according to the following general reaction:

(2n+1)H₂+nCO→CₙH₍₂ₙ₊₂₎+nH₂O

During the conversion of syngas into paraffinic compounds also water is formed. This water exits the FT reactor as a waste water stream.

Next to the formation of hydrocarbons, organic molecules containing oxygen can be formed during the Fischer-Tropsch process. These compounds are referred to as oxygenated compounds or oxygenates. Oxygenates include alcohols, aldehydes, ketones and organic acids.

In environmental chemistry, the chemical oxygen demand (COD) test is commonly used to indirectly measure the amount of such organic compounds in water, whereby COD is expressed in milligrams per litre (mg/l) or parts per million weight (ppmwt).

The basis for the COD test is that nearly all organic compounds can be fully oxidized to carbon dioxide with a strong oxidizing agent under acidic conditions. The amount of oxygen required to oxidize an organic compound to carbon dioxide, ammonia, and water is given by:

COD=(C/FW)(RMO)(32)

Where:

C=Concentration of oxidizable compound in the sample,

FW=Formula weight of the oxidizable compound in the sample,

RMO=Ratio of the # of moles of oxygen to # of moles of oxidizable compound in their reaction to CO2, water, and ammonia.

The International Organization for Standardization describes a standard method for measuring chemical oxygen demand in ISO 6060.

In GTL plants a substantial amount of water is produced which exits the FT reactor as a waste water stream. This waste water comprises trace metals and oxygenates. Due to the presence of trace metals and oxygenates the water requires treatment before it can be discharged. The required water treatment to remove the trace metals and oxygenates from the waste water stream requires elaborate and costly water treatment plants.

US2008/119574 discloses a method of recycling a waste water stream from a Fischer-Tropsch reaction by feeding the waste water to an upstream saturator. The waste water stream comprises oxygenates. A disadvantage of recycling waste water together with oxygenates is that the organic acids cannot be stripped from water resulting in the acids exiting the saturator together with the waste water of the saturator. Consequently, this waste water is highly acidic and requires elaborate and costly waste water treatment installations for treating this water. Further since the acids are not recycled this has a negative effect on the efficiency of the conversion of feedstock gas into paraffin.

As specified above, the saturator generally has the function of providing the water vapour necessary for saturating the process gas, preferably natural gas, usually methane, before feeding this to the synthesis gas production unit. In the saturator, water is generally brought in counter-current contact with the above preheated process gas. Any state of the art gas saturator can be advantageously amended for the purposes of the present invention. Saturators are typically unpacked (spray towers), packed (with structured or unstructured packing) or trayed columns/vessels allowing heat and mass transfer as required to perform the water saturation.

Feeding waste water coming from the Fischer-Tropsch reaction directly to the saturator can cause various problems. The organic compounds present in this water can cause corrosion of the equipments such as reactors and pipes, result in unwanted foaming and/or can cause poisoning of the catalysts.

### SUMMARY OF THE INVENTION

It is an object of the present invention to provide for a means to reduce fresh water/steam usage in syngas production.

It is an object to provide for an improved means of converting oxygenates in waste water to valuable hydrocarbons.

The present inventors have found that the water/steam demand in syngas production can be reduced by recycling waste water containing oxygenates obtained from a GTL plant (such as a waste stream from a Fischer-Tropsch reactor) in a gas saturator provided with a catalytic bed to convert oxygenates into hydrocarbons. Converting oxygenates to hydrocarbons in the saturator reduces the amount of water requiring treatment as well as the treatment requirements of waste water from the Fischer-Tropsch reactor. This improvement is caused by two phenomenon:

1) conversion of oxygenates to hydrocarbons, the majority of which being carried with the saturated gas;

2) a portion of the water is being carried with the saturated gas.

The continuous removal of the conversion products by the feedstock gas flowing through the catalyst bed a shift of the chemical equilibrium to increase the chemical conversion by separation of the conversion products is achieved. In other words the reaction products are continuously removed from the reaction mixture whereby chemical equilibrium cannot be established, resulting in high reaction rates.

Therefore, due to the reuse of waste water, less waste water is generated by a GTL plant that requires treatment and the degree of treatment will be less.

Another advantage of the present invention is that the hydrocarbons produced in the catalytic saturator contribute to syngas production. Thereby, increasing feedstock gas (a carbonaceous gas) conversion.

### DETAILED DESCRIPTION OF THE INVENTION

The present invention relates to a gas saturator for providing water to a feed gas. The saturator comprises a vessel that is provided with at least:

i. An inlet for a feed gas stream;

ii. An inlet for a hydrogen containing gas stream;

iii. An inlet for at least one waste water stream from a Fischer-Tropsch reactor, the at least one waste water stream comprising oxygenates;

iv. An outlet for a gas mixture stream comprising feed gas, water and hydrocarbons;

v. An outlet for a second waste water stream comprising oxygenates.

The present invention further relates to a method for recycling waste water from a Fischer-Tropsch reactor and is preferably part of a process for manufacturing synthesis gas. Said method comprises the steps of:
Operating a gas saturator comprising a catalyst bed for converting oxygenates at a temperature ranging from 100−300° C. and at a pressure in the range of 1-100 barg;
Providing during operation of the saturator, waste water comprising oxygenates from the Fischer-Tropsch reactor to the top of the catalyst bed;
Providing hydrogen containing gas to the gas saturator such that the oxygenates from the waste water and the hydrogen contact the catalyst in the catalyst bed counter-currently such that at least part of the oxygenates are converted into hydrocarbons;
Providing a feedstock gas to the gas saturator such that it moves through the catalyst bed counter-currently compared to the oxygenates.

The present invention relates to a system for manufacturing synthesis gas including the recycling of waste water from a Fischer-Tropsch reaction, comprising:
a Fischer-Tropsch reactor having a waste water stream comprising oxygenates;
a synthesis gas reformer coupled to and upstream of the Fischer-Tropsch reactor; and
a gas saturator according to the present invention coupled to and upstream of the synthesis gas reformer, and coupled to an upstream feed gas stream source, and means for providing waste water originating from a downstream Fischer-Tropsch reactor, to provide a saturated feed gas stream, comprising feed gas, water and hydrocarbons obtained from the conversion of oxygenates from the Fischer-Tropsch reactor waste water stream, to the synthesis gas reformer.

The terms upstream and downstream are relative to the direction of flow of the feed gas. Hence the system comprises in the direction the feed gas flows, a saturator followed by a synthesis gas reformer followed by a Fischer-Tropsch reactor.

The feed stock gas can be natural gas, associated gas and/or coal-bed methane or a carbonaceous gas obtained from heavy and/or residual oil fractions, coal or biomass. The feed gas can be treated prior to provision to the saturator. For example the feed gas can be treated in order to remove impurities or contaminants from the stream. An example is the removal of sulfur from natural gas.

The hydrogen containing gas may be pure hydrogen, synthesis gas, Fischer-Tropsch off-gas or a combination thereof. The synthesis gas or Fischer-Tropsch off gas may be treated such that the hydrogen content is increased. This may be achieved by removal of other ingredients by pressure swing adsorption column and/or a water shift reactor.

The vessel of the saturator is further provided with a catalyst for converting oxygenates into hydrocarbons. Preferably the oxygenates are converted at least by hydro-deoxygenation (HDO).

The gas mixture exiting the saturator comprises feed gas, water and hydrocarbons. The hydrocarbons are obtained by converting oxygenates from the waste water stream to hydrocarbons. These hydrocarbons are formed in the part of the saturator comprising the catalyst. The hydrocarbons are transported out of the catalytic section by the feed gas and residual hydrogen gas flowing through the catalyst bed.

The second waste water stream comprises oxygenates which are not stripped from the water in the saturator.

These oxygenates comprise acids. Said second waste water stream is composed of excess treated water which has not vaporized and entered the gas stream. With treated water is meant water which has been in contact with the catalyst.

The outlet for removing excess treated water as a second waste water stream, the second outlet is provided in the bottom part of the vessel.

In an embodiment the waste water stream is derived at least from a Fischer-Tropsch reactor present in a GTL plant.

In an embodiment of the present invention the vessel of the saturator has (from top to bottom) a top section, catalytic counter-current packed bed contact section, a non-catalytic counter-current packed bed or trayed contact section, and a bottom section. The packed beds or trayed contact internals facilitate heat and mass transfer. The inlet for hydrogen containing gas and water outlet is at the bottom part, trays or packing are placed in the non-catalytic part, the inlet for the feedstock gas is provided between the catalytic and non-catalytic section, and the inlet for the waste water and outlet for the gas mixture are provided at the top section.

The vessel may be a vessel that can withstand operational conditions at elevated temperature and elevated pressure.

In an embodiment the inlets and outlets are arranged such that the hydrogen gas and waste water are counter-currently contacted with the HDO catalyst. In other words the oxygenates and hydrogen are counter-currently contacted with the catalyst.

In an embodiment of the present invention, trays or packing (or the combination of both) are placed in the non-catalytic section.

A gas saturator according to the present invention can further be provided with a means for holding the catalyst in the saturator, said means being such that the required heat and mass transfer and the conversion reaction can take place simultaneously.

An example of means for holding said catalyst is a catalytic bed with a crisscrossing sandwich structure. Said structure generates a radial and axial liquid phase dispersion within the catalytically packed and therewith the head and mass transfer. The catalyst particles are “sandwiched” between corrugated sheets of wire gauze. Two pieces of rectangular crimped wire gauze are sealed to form a pocket. These catalyst “sandwiches” or “wafers” are alternating with corrugated sheets forming a structured packing element. Such structured packings are sold for example by Sulzer, under the product name KATAPAK-S, and Koch-Glitsch, under the product name KATAMAX.

In an embodiment of the present invention the vessel of the saturator is further provided with a CO shift catalyst. Preferably, both catalysts can be present in a stacked bed in which both catalysts are present in separates zones in the bed or both catalysts are present in a mixed bed.

In an embodiment of the gas saturator according to the present invention, the inlet for waste water is provided with a liquid distributor to distribute the waste water over the cross section of the catalytic section. Preferably, the distributors are positioned such that the waste water is substantially equally distributed over the cross section of the catalytic section.

In an embodiment of the present invention the hydrogen containing gas comprises at least Fischer-Tropsch off-gas. In case Fischer-Tropsch off-gas is used as the hydrogen source for converting oxygenates into hydrocarbons the saturator can be connected directly to one or more Fischer-Tropsch reactors. Alternatively, the Fischer-Tropsch off-gas is treated prior to entry into the saturator. Treatment includes adjusting the temperature of the off-gas, adding hydrogen, removing certain pollutants or combinations thereof. The off gas can be subjected to a water shift reaction in order to increase the hydrogen content. Further, inerts like nitrogen may be removed in order to prevent the build-up of inerts in the system due to the recycling of off gas. Inerts may be removed by using pressure swing adsorption columns.

In an embodiment of the present invention the catalyst comprises a catalytically active material and a carrier material. Preferably, said catalytic material comprises one or more metals and preferably is selected from the group consisting of Ru, Rh, Pt, WOₓ, Pd and combinations thereof. Preferably, said carrier material is selected from the group consisting of carbon, ZrO₂, Al₂O₃, titania, ceria, SiC, zeolites such as ZSM-5 or combinations thereof. The conversion of oxygenates to alkanes is preferably established via at least hydro-deoxygenation (HDO). Preferably, the catalyst comprises ruthenium and more preferred ruthenium supported on carbon, ZrO₂ or Al2O3.

In an embodiment of the present invention the saturator is operated at a temperature of 100-300° C., preferable at a temperature ranging from 175-275° C., for example around 250° C. The present inventors have found that in these temperature ranges good results are obtained with respect to the conversion of oxygenates to hydrocarbons while maintaining saturation of the gas mixture stream exiting the saturator.

In an embodiment of the present invention the saturator is operated at a pressure ranging from 1-100 barg, preferably from 30-60 barg, for example around 45 barg. The present inventors have found that in these pressure ranges good results are obtained with respect to the conversion of oxygenates to hydrocarbons while maintaining saturation of the gas mixture stream exiting the saturator.

In an embodiment the catalyst is provided to a shaped body. The body can be composed of a metal or metal alloy to which the catalysts are connected. The shaped body can be ring shaped or tubular shaped in order to increase the surface area of shaped body. The increase in surface area of the shaped structure will result in an increase in surface area of the catalyst available for the conversion of oxygenates to hydrocarbons.

In an embodiment the waste water stream comprises hydrocarbons and oxygenates such as alcohols, aldehydes, ketones, carboxylic acids, and a COD of up to 5 wt % and preferably in the range of 1.6 wt % to 2.0 wt %. In methods according to the prior art organic compounds contributing to COD are removed from waste water streams by means of physical, chemical and/or biological and biochemical processes. The COD load is important for biological processes since the COD load determines mainly the size and operating costs of the biotreater. An often used pretreatment process to remove COD contaminants from waste water streams is to subject the waste water streams to a distillation step in which the COD contaminants are stripped off water in a distillation column and separately recovered. These water treatment plants are very complex and costly to operate and maintain. The saturator, method and system according to the present invention provide for a more simplified way of treating waste water and reuse of the waste water in the manufacturing of synthesis gas. This is especially advantageous for gas to liquids plants as these are often located at remote places.

The waste water may originate from a Fischer-Tropsch reactors such as fixed bed reactors, especially multi-tubular fixed bed reactors, fluidized bed reactors, such as entrained fluidized bed reactors and fixed fluidized bed reactors, and slurry bed reactors such as three-phase slurry bubble columns and ebulated bed reactors. Preferably, the waste water originates from a tubular fixed bed reactor comprising a cobalt based Fischer-Tropsch catalyst.

In an embodiment of the present invention part of the water that does not leave the saturator in the gas mixture stream exits the gas saturator via the second waste water outlet. The waste water exiting the saturator comprises less oxygenates than the amount of oxygenates entering the saturator in the first waste water stream.

The waste water is provided to the top of the catalyst bed comprising the catalyst. The hydrogen containing gas is provided to the bottom of the catalyst bed. This allows for the oxygenates present in the waste water and the hydrogen to contact the catalyst counter-currently. Further the feedstock gas is provided to the saturator below the catalyst bed. This allows for the feedstock gas to transport hydrocarbons formed by the reaction out of the catalyst bed and out of the saturator to the reformer.

In an embodiment of the present invention the hydrocarbons exit the gas saturator with the gas mixture of water and the carbonaceous feedstock gas. Preferably, the obtained gas mixture is provided to a syngas producing unit. Such a unit can be an auto-thermal reformer. Hence, in an embodiment the method according to the present invention comprises a further step of providing the gas mixture obtained from the gas saturator to at least one synthesis gas producing reactor. The obtained synthesis gas may be provided to a Fischer-Tropsch reactor or may be used to obtain hydrogen.

In an embodiment of the present invention a portion and preferably at least 60% of the waste water produced by the GTL plant is provided to one or more gas saturators according to the present invention.

In an embodiment of the present invention at least part of the hydrogen containing gas is obtained at least from the Fischer-Tropsch reactor as Fischer-Tropsch off-gas. In case the hydrogen content of the off-gas is to low hydrogen can be added from an external source. Hydrogen may be added in the form of pure hydrogen.

In an embodiment of the present invention the saturator further comprises at least one inlet for providing steam/water vapor. In order to further increase the water content of the gas mixture leaving the saturator steam/water vapor can be added via this inlet.

In the reformer the gas obtained from the saturator is converted into synthesis gas. Synthesis gas is a gas mixture comprising at least hydrogen (H₂) and carbon monoxide (as discussed previously). Also, at least part of, the hydrocarbons formed in the saturator are converted into carbon monoxide and hydrogen. The conversion of these hydrocarbons increases the efficiency of the system since the carbon atoms normally disposed together with the waste water stream are now made available for reuse in the Fischer-Tropsch reactor.

Preferably the waste water originates at least partially from at least one Fischer-Tropsch reactor within the GTL-plant.

### FIGURES

The invention will be further illustrated by the figures depicting several non-limiting embodiments of the present invention.

FIG. 1 is a schematic representation of an embodiment of the present invention.

FIG. 2 is a schematic representation of a saturator according to the present invention with integrated heat system.

FIG. 3 is a schematic representation of a system according to the present invention.

FIG. 4 shows oxygenate conversion results obtained for two catalysts.

FIG. 1 shows a schematic representation of a saturator (1) according to the present invention. The arrows represent the different streams and their respective directions. The vessel (2) of the saturator (1) has (from top to bottom) a top section (3), a catalytic section (4) which preferably comprises a counter-current packed bed contact section, a non-catalytic section (5) preferably comprising a counter-current packed bed or trayed contact section, and a bottom section (6). The inlet (7) for hydrogen containing gas and waste water outlet (8) are at the bottom section (6), the inlet (9) for the feedstock gas is provided in catalytic section (4) where catalyst is provided or just underneath thereof, and the inlet (10) for the waste water and outlet (11) for the gas mixture are provided at the top section (3).

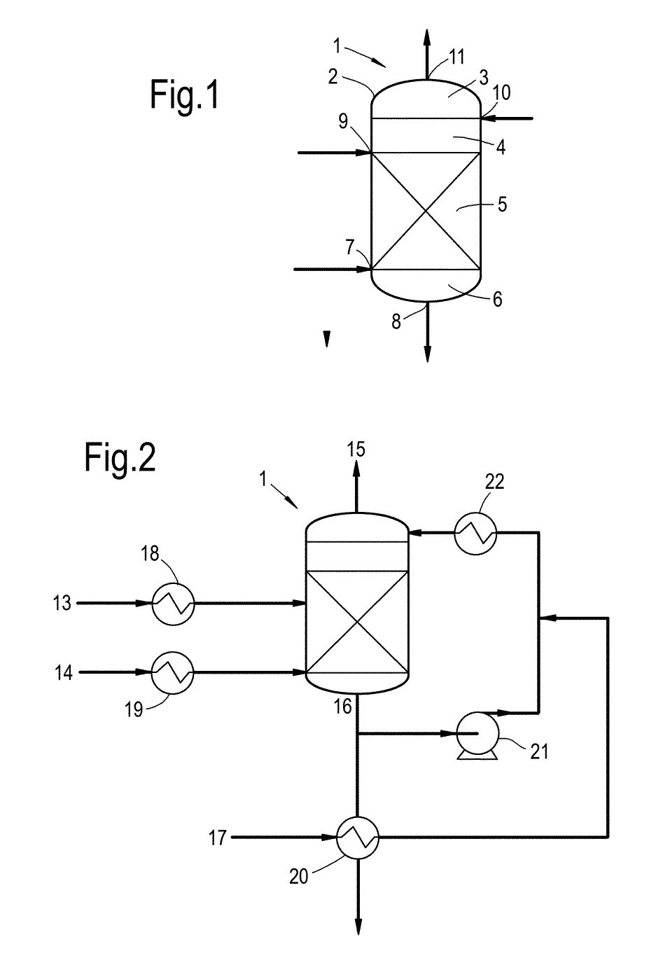

FIG. 2 depicts a saturator (1) according to the present invention with an integrated heating system. Carbonaceous feed gas is provided to the saturator (1) via conduit 13. Prior to entry into the saturator, the carbonaceous gas is heated by heater 18. A hydrogen containing gas is provided to the saturator (1) via conduit 14. The hydrogen containing gas is heated by heater 19 prior to entry into the saturator (1). Waste water, from the Fischer-Tropsch reactor is provided to the saturator (1) via conduit 17. The waste water is heated prior to entry into the saturator (1) by heater 20 and 22. Preferably, the heating of FT waste water by heater 20 is achieved by means of exchanging heat from effluent water leaving the saturator (1) via conduit 16, to the FT waste water. Part of the effluent water can also be recycled by means of pump 21 to the saturator (1).

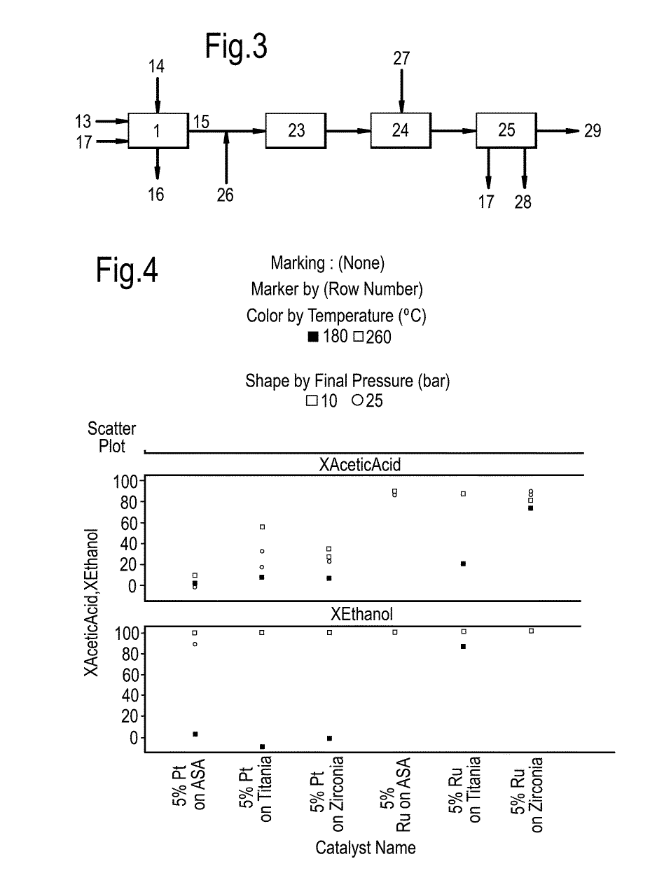

FIG. 3 depicts an example of a system according to the present invention. In this figure items indicated with 1, 13, 14, 15, 16, 17 correspond to the items with the same numbers in FIGS. 1 and 2. To the saturated gas of stream 15 additional stream (26) can be added after which the saturated gas is fed to a pre-reformer (23). The pre-reformed gas is fed to an auto-thermal reformer (ATR; 24). The ATR (24) is also provided with oxygen. The obtained synthesis gas is fed to the Fischer-Tropsch (FT) reactor (25). The Fischer-Tropsch synthesis product (29), FT waste water (17) and Fischer-Tropsch off gas (28) exit the FT reactor (25).

### EXAMPLES

The present invention will further be illustrated by the following non limiting examples.

### Example 1

The experiments were conducted in a QCS Batch Reactor system consists of 12 independent cylindrical reactors. The unit is built in stainless steel. Every time a new experiment is performed, the reactors are covered with a disposable Teflon insert to prevent cross-contamination in different experiments. Next, the required mass of catalyst and a Teflon magnet are introduced and liquid volume added. A Teflon septum is then placed on top of each reactor and the QCS lid is closed by tightening bolts. A gas atmosphere is introduced via needles that penetrate through the Teflon septum. Once the system is ready, it is placed in the heating platform, where the reaction will proceed for the required duration. The reaction can is stopped by cooling down (typically over ice). Once room temperature is reached, the catalyst+liquid sample is transferred into a Teflon eppendorf and centrifuged at 3000 rpm for 10 min. After centrifuging an aliquot of the liquid supernatant is taken for analysis, which is typically carried by gas chromatography.

A number of catalysts based on Ru, Ir, Pt or Pd where investigated with respect to the effect of Temperature (T), pressure (P), time (t), and catalyst intake.

Four different conditions were tested:

1.260° C., 25 bar (final pressure; 14 bar hydrogen, 11 bar steam), 10 mg catalyst;

2.260° C., 10 bar (final pressure; 14 bar hydrogen, 11 bar steam), 10 mg catalyst;

3.180° C., 10 bar (final pressure; 6.6 bar hydrogen, 3.4 bar steam), 10 mg catalyst;

4.260° C., 25 bar (final pressure; 14 bar hydrogen, 11 bar steam), 5 mg catalyst.

For two catalysts, supported Ru and Pt, the oxygenate conversion is shown in FIG. 2. This figure shows the effect of metal, support and process conditions on the conversion of acetic acid and ethanol.

As can be observed, full conversion of ethanol is possible with both Ru and Pt catalysts. For Pt-based catalysts a high temperature is required, whereas Ru catalysts show high activity also at low (compared to Ru) temperatures and low (10 bar) final pressure. For acetic acid conversion the Ru catalyst shows the highest activity.

These results show also that the carrier material has an effect on the catalyst activity.

### Example 2

Conversion tests were conducted for catalysts based on Ru. The experiments were conducted as described in Example 1.

For the Ru catalysts a lower conversion was found for hexanoic acid as compared to acetic acid. See the results of Ru/ZrO₂ in Table 1. From this table, and also from data found for other catalysts, it is concluded that a high T and high P generally are beneficial for oxygenates conversion. Interestingly, lowering the catalyst intake by a factor two hardly changes the conversion of the acids.

TABLE 1
Effect of pressure, temperature (T) and catalyst mass on the conversion of oxygenates
by 5% Ru/ZrO2. Conversion was obtained by comparing initial concentrations
and the concentrations obtained after catalytic test.

| | Pressure | | Conversion (%) | | | | |
|---|---|---|---|---|---|---|---|
| T | (Bar) | Mcat | Acetic | | | Hexanoic | |
| (° C. ) | [H₂, steam] | (mg) | Acid | Ethanol | Propanal | Acid | Pentanol |
| 260 | 25 | 10 | 88 | 100 | 100 | 76 | 100 |
| | [14, 11] | | | | | | |
| 260 | 10 | 10 | 79 | 100 | 100 | 70 | 100 |
| | [5.6, 4.4] | | | | | | |
| 180 | 10 | 10 | 72 | 100 | 100 | 59 | 100 |
| | [6.6, 3.4] | | | | | | |
| 260 | 25 | 5 | 85 | 100 | 100 | 75 | 100 |
| | [14, 11] | | | | | | |

For most catalysts a high conversion (>90%) of ethanol, propanal and pentanol was found irrespective of pressure (10, 25 bar) and temperature (180, 260° C.)

The appended claims also form part of the description by means of this reference.

1. A method for recycling waste water of a Fischer-Tropsch reactor comprising the steps of:
a. Operating a gas saturator comprising a catalyst bed for converting oxygenates at a temperature ranging from 100-300° C. and at a pressure in the range of 1-100 barg;
b. Providing during operation of the saturator, waste water comprising oxygenates from the Fischer-Tropsch reactor to the top of the catalyst bed;
c. Providing hydrogen containing gas to the gas saturator such that the oxygenates from the waste water and the hydrogen contact the catalyst in the catalyst bed counter-currently such that at least part of the oxygenates are converted into hydrocarbons;
d. Providing a feedstock gas to the gas saturator such that it moves through the catalyst bed counter-currently compared to the oxygenates.

2. A method according to claim 1 wherein the hydrocarbons exit the gas saturator with the gas mixture of water and natural gas.

3. A method according to claim 1 wherein a portion of waste water produced by a GTL plant is provided to at least one gas saturator.

4. A method according to claim 1 wherein at least a part of the water exits the saturator together with the gas mixture.

5. A method according to claim 1 wherein at least part of the hydrogen containing gas is obtained from the Fischer-Tropsch reactor as Fischer-Tropsch off-gas.

6. A method according to claim 1 wherein the oxygenates are contacted with a catalytic material comprising one or more metals selected from the group consisting of Ru, Rh, Pt, WOx, Pd and combinations thereof.

7. A gas saturator for providing water to a feed gas, comprising a vessel that is provided with at least:
i. An inlet for a feed gas stream;
ii. An inlet for a hydrogen containing gas stream;
iii. An inlet for at least one (first) waste water stream from a Fischer-Tropsch reactor, comprising oxygenates;
iv. An outlet for a gas mixture stream comprising feed gas, water and hydrocarbons; and
v. An outlet for a second waste water stream comprising oxygenates; wherein the vessel of the saturator is provided with a catalyst for converting oxygenates into hydrocarbons.

8. A gas saturator according to claim 7 wherein the inlet for waste water is provided with a liquid distributor to distribute the waste water over the cross section of the catalytic section.

9. A gas saturator according to claim 7, wherein the saturator is provided with a means for holding the catalyst in the saturator, said means being such that heat and mass transfer and the conversion reaction can take place simultaneously when the hydrogen containing gas and natural gas contact the water at the catalyst surface.

10. A gas saturator according to claim 7 wherein the vessel has (from top to bottom) a top section, a catalytic section comprising as means for holding the catalyst a catalytic counter-current packed bed contact section, a non-catalytic counter-current packed bed or trayed contact section, and a bottom section.

11. A gas saturator according to claim 10 wherein, the inlet for hydrogen containing gas is located at the bottom section.

12. A gas saturator according to claim 10 wherein, the inlet for the feedstock gas is provided between the non-catalytic and catalytic section through a vapor distribution device and where the inlet for the first waste water stream and the outlet for the gas mixture are provided at the top section.

13. A gas saturator according to claim 7 wherein the saturator is provided with trays or packing or a combination of both.

14. A method according to claim 1 wherein at least a saturator is used.

15. A system for recycling waste water from a Fischer-Tropsch reaction, comprising:
a. a Fischer-Tropsch reactor having a waste water stream comprising oxygenates;
b. a synthesis gas reformer coupled to and upstream of the Fischer-Tropsch reactor; and
c. a gas saturator according to claim 6 coupled to and upstream of the synthesis gas reformer, and coupled to an upstream feed gas stream source, and means for providing waste water originating from a downstream Fischer-Tropsch reactor, to provide a saturated feed gas stream, comprising feed gas, water and hydrocarbons obtained from the conversion of oxygenates from the Fischer-Tropsch reactor waste water stream, to the synthesis gas reformer
